(19) United States
(12) Patent Application Publication
(10) Pub. No.: US 2018/0162691 A1
(43) Pub. Date: Jun. 14, 2018

(54) ELEVATOR SAFETY SYSTEM, ELEVATOR SYSTEM AND METHOD OF OPERATING AN ELEVATOR SYSTEM

(71) Applicant: Otis Elevator Company, Farmington, CT (US)

(72) Inventors: Peter Herkel, Berlin (DE); Dirk H. Tegtmeier, Berlin (DE)

(21) Appl. No.: 15/831,654

(22) Filed: Dec. 5, 2017

(30) Foreign Application Priority Data
Dec. 9, 2016 (EP) 16203112.4

(51) Int. Cl. B66B 5/00; B66B 5/02; B66B 13/22; B66B 13/14

(52) U.S. Cl. CPC B66B 5/0031; B66B 13/143; B66B 13/22; B66B 5/02

(57) ABSTRACT

An elevator safety system comprises a plurality of door safety units (12), wherein each door safety unit (12) is configured to monitor at least one door (10, 11) of an elevator system (2); an elevator control unit (13), which is configured to control the elevator system (2), in particular to control movement of an elevator car (6) of the elevator system (2); a communication bus (14), which is configured for transmitting information between the plurality of door safety units (12) and the elevator control unit (13); and a signal line (16) serially connecting the elevator control unit (13) and the plurality of door safety units (12). Each of the plurality of door safety units (12) is configured to interrupt the signal line (16) when it detects a malfunction.

The invention relates to an elevator safety system, an elevator system and to a method of operating an elevator system.

Traditionally, elevator systems comprise hoistway door contacts, which are configured to monitor the movement of the hoistway doors. The hoistway door contacts are serially connected with each other forming a daisy chain. The daisy chain is a part of an elevator safety chain. Any malfunction of a hoistway door or a hoistway door contact interrupts the daisy chain/safety chain, which results in stopping any further movement of the elevator car. As all hoistway door contacts are connected serially with each other, the diagnostic information, which is available after the safety chain has been interrupted, is very poor. It in particular does not allow to locate the door contact interrupting the daisy chain. Thus, in this kind of elevator systems, identifying the faulty hoistway door or hoistway door contact is time consuming.

More modern safety systems employ door safety units, which are connected to a safety bus. While such systems principally allow to identify the door safety unit, which causes the interruption of the daisy chain/safety chain, the amount of data communicated via the safety bus is large compared to the available bandwidth and thus the message indicating malfunction of a hoistway door might be transferred with a delay, which is undesirably.

It therefore would be beneficial to provide an improved elevator safety system which allows to detect and locate errors more easily but without delay.

According to an exemplary embodiment of the invention, an elevator safety system comprises: a plurality of door safety units, an elevator control unit, a communication bus and a signal line serially connecting the elevator control unit and the plurality of door safety units. Each door safety unit is configured to monitor at least one door, in particular a hoistway door, of an elevator system. The elevator control unit is configured to control the elevator system, in particular to control the movement of an elevator car of the elevator system. The communication bus is configured for transmitting information between the plurality of door safety units and the elevator control unit. The communication further bus may be configured for transmitting information between other units e.g. hall call units and the elevator control unit. Each of the plurality of door safety units is configured to selectively interrupt the signal line if a malfunction is detected. In the context of the present invention, a “malfunction” in particular includes a situation in which the at least one door is not properly closed although it is supposed to be.

Exemplary embodiments of the invention further include an elevator system comprising a hoistway extending between a plurality of landings; an elevator car, which is configured to move along the hoistway between the plurality of landings;

a drive unit for driving the elevator car; and an elevator safety system according to an exemplary embodiment of the invention, wherein the elevator control unit is configured for controlling the drive unit.

According to an exemplary embodiment of the invention, a method of controlling such an elevator system comprises: monitoring at least one door of an elevator system by means of one of the door safety units. If a malfunction of at least one of the doors or door safety units is detected, the signal line is interrupted in order to stop and prevent any movement of the elevator car. Additionally, information from the door safety unit interrupting the signal line is transmitted to the elevator control unit.

According to a further exemplary embodiment of the invention, a method of controlling such an elevator system comprises: monitoring at least one door of an elevator system by means of one of the door safety units. If a malfunction of at least one of the doors or door safety units is detected, the signal line is interrupted in order to stop and prevent any movement of the elevator car. Additionally, information from the door safety unit interrupting the signal line is transmitted to the elevator control unit.

In an elevator safety system according to an exemplary embodiment of the invention, the time critical information that any kind of malfunction has been detected by one of the door safety units is signaled to the elevator control unit without delay by electrically interrupting the signal line. Additional information about the detected malfunction, which is not as time critical as the information that a malfunction has been detected, is transmitted to the elevator control unit via the communication bus. This allows to transmit additional information about the detected malfunction, which facilitates the location of the malfunction and in turn the repair of the elevator system. Since the time critical information that a malfunction of the elevator system has been detected is communicated fast, i.e. without delay, by electrically interrupting the signal line, the safety of the elevator system is not deteriorated by the transmission of information via the communication bus, which may take more time than transmitting the signal by interrupting the signal line.

In the following an exemplary embodiment of the invention is described with reference to the enclosed figures.

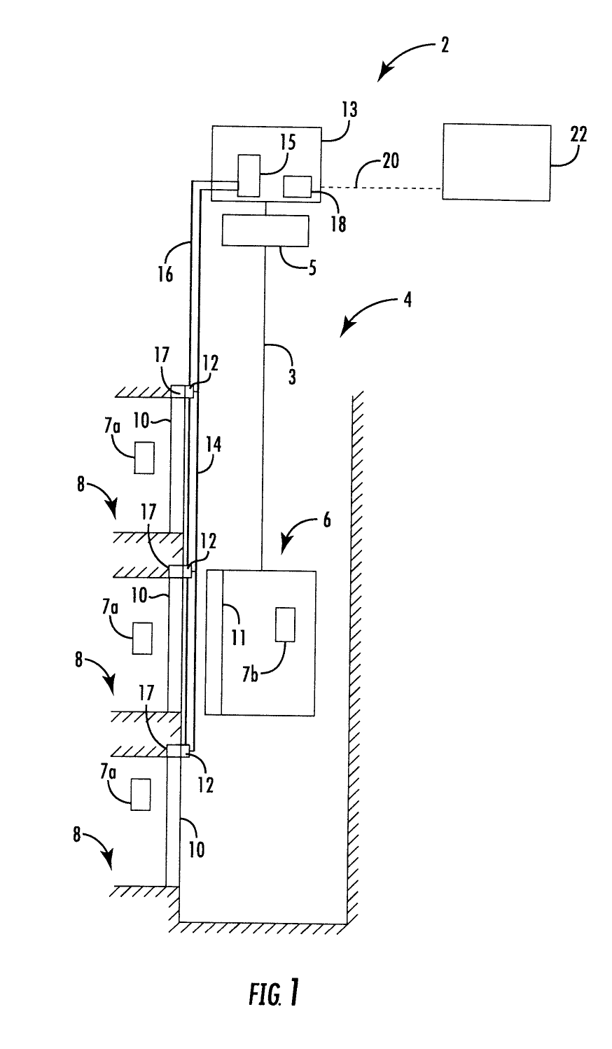

FIG. 1 schematically depicts an elevator system according to an exemplary embodiment of the invention.

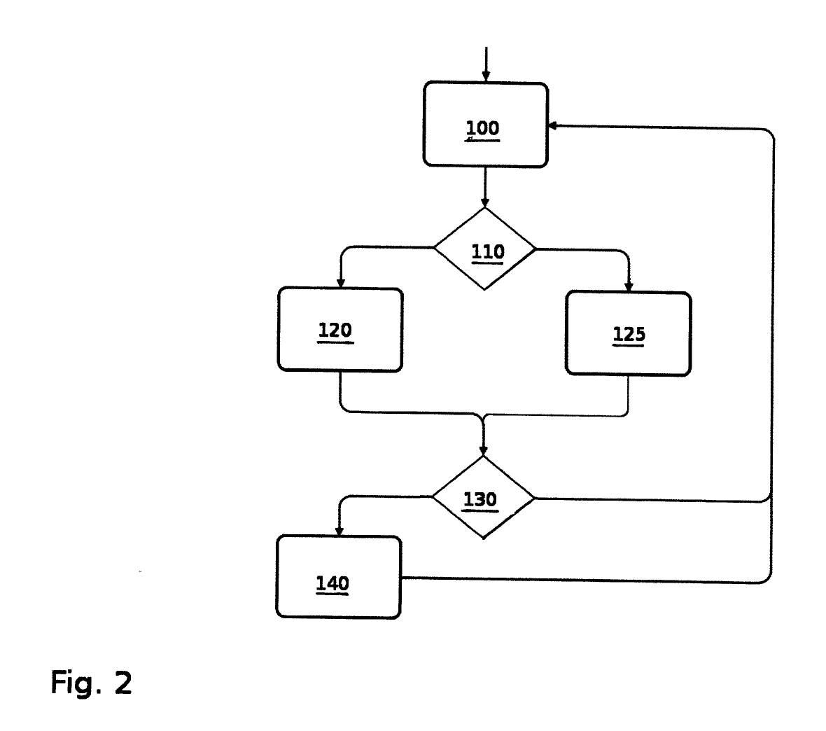

FIG. 2 is a flow diagram illustrating the operation of a door safety unit as it is employed in an elevator system according to an exemplary embodiment of the invention.

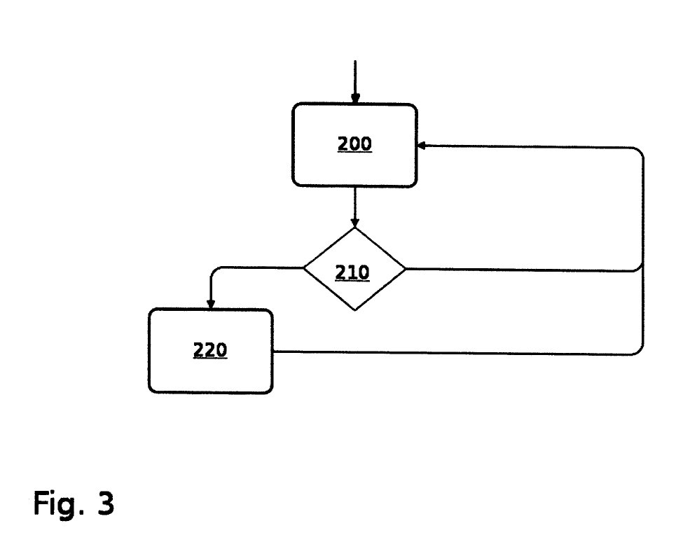

FIG. 3 is a flow diagram illustrating the operation of a door safety unit for periodically transmitting information via the communication bus.

FIG. 1 schematically depicts an elevator system 2 according to an exemplary embodiment of the invention.

The elevator system 2 comprises an elevator car 6 which is movably suspended within a hoistway 4 extending between a plurality of landings 8, which are located on different floors.

The elevator car 6 is movably suspended by means of a tension member 3. The tension member 3, for example a rope or belt, is connected to an elevator drive unit 5, which is configured for driving the tension member 3 in order to move the elevator car 6 along the height of the hoistway 4 between the plurality of landings 8.

Each landing 8 is provided with a landing door 10, and the elevator car 6 is provided with a corresponding elevator car door 11 for allowing passengers to transfer between a landing 8 and the interior of the elevator car 6 when the elevator car 6 is positioned at the respective landing 8.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping, may be used as well. The elevator system 2 may use a counterweight (not shown) or not. The elevator drive unit 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive or a linear drive (not shown).

The elevator drive unit 5 is controlled by an elevator control unit 13 for moving the elevator car 6 along the hoistway 4 between the different landings 8.

Input to the elevator control unit 13 may be provided via landing control panels 7a, which are provided on each landing 8 close to the landing doors 10, and/or via a car operation panel 7b provided inside the elevator car 6.

The landing control panels 7a and the car operation panel 7b may be connected to the elevator control unit 13 by means of electrical lines, which are not shown in FIG. 1, in particular by an electric bus, or by means of wireless data connections.

A door safety unit 12 is provided at every landing 8. At least one door sensor 17, in particular a landing door sensor 17, which is configured for monitoring the operation, in particular the opening and closing, of an associated landing door 10, is associated and electrically connected with each of the door safety units 12.

Each of the door safety units 12 is connected to a communication bus 14, which extends along the hoistway 4 between the plurality of landings 8. The communication bus 14, which in particular may be a field bus, e.g. CAN bus, is configured to allow communication between each of the plurality of door safety units 12 and the elevator control unit 13, in particular an elevator safety unit 15 being part of the elevator control unit 13. Optionally, the communication bus 14 may be employed for additionally transmitting information between the landing control panels 7a and the elevator control unit 13. Alternatively, a separate bus (not shown) may be used for transmitting information between the landing control panels 7a and the elevator control unit 13.

The communication bus 14 uses a predefined data protocol for communicating instructions between bus nodes connected to the communication bus 14. The door safety units 12 may be provided as bus nodes connected to the communication bus 14. A number of different communication buses 14 and related data protocols are used in the art and known to the skilled person.

When at least one of the door safety units 12 detects a malfunction of an associated landing door sensor 17 and/or landing door 10, it opens a contact (not shown), which electrically interrupts a signal line 16. The signal line 16 runs parallel to the communication bus 14 and electrically connects the door safety units 12 with the elevator safety unit 15 in the form of a daisy chain in which the door safety units 12 are connected serially with each other.

Additionally, the at least one of the door safety units 12 sends a failure signal indicating the detected malfunction via the communication bus 14 to the elevator safety unit 15.

As soon as the elevator safety unit 15 receives a failure signal via the communication bus 14 and/or detects an interruption of the signal line (daisy chain) 16, it reacts appropriately, e.g. by immediately stopping any further movement of the elevator car 6.

Interrupting the signal line (daisy chain) 16 does not provide any information about the nature and location of the detected malfunction. In consequence, without any further information available, a mechanic would have to visit the site and check all landing doors 10 in order to locate the cause of the malfunction.

Therefore the door safety unit 12 detecting the malfunction sends information, in particular information which allows to identify the door safety unit 12 sending the message and/or information which allows to identify the kind of detected malfunction, via the communication bus 14. The additional information sent by the door safety unit 12, which may be part of the failure signal, or which may be sent after the failure signal has been sent, allows to locate and identify the cause of the malfunction fast and easily. Particularly, the elevator safety unit 15 may obtain this information autonomously.

Optionally, the information may be additionally sent by a communication unit 18, which is provided within or connected with the elevator control unit 13, via an external communication line 20 to an external service center 22. The external service center 22 may instruct a mechanic to visit the elevator system 2 in order to solve the detected problem. Based on the information provided by the communication unit 18 the mechanic may take the tools and/or spare parts, which are needed for solving the problem, with him in order to facilitate and speed up the repair process.

The external communication line 20 may include a conventional telephone line or a digital line such as ISDN or DSL. It further may include wireless communication including WLAN, GMS, UMTS, LTE, Bluetooth® etc.

Depending on the circumstances and the protocol which is used for running the communication bus 14, the speed of transferring the information from the door safety units 12 to the elevator control unit 13 via the communication bus 14 may be too slow in order to allow a safe operation of the elevators system 2 under all operational conditions. Thus, the separate signal line 16 is provided in addition to the communication bus 14 in order to allow for a fast transmission of the failure signal.

In consequence, an elevator system 2 according to an embodiment of the invention comprises two communication lines: A fast signal line 16, which is configured to transmit only simple, in particular binary, information fast, i.e. with low latency, from the door safety units 12 to the elevator safety unit 15 in order to allow the elevator control system 13 to react fast when a malfunction is detected. Said fast signal line 16, however, is not necessarily configured to transmit additional information about the detected malfunction. Thus, in order to allow to transmit further information, which is related to the location and/or to the kind of the detected malfunction, an elevator safety system according to an embodiment of the invention additionally comprises a communication bus 14. The communication bus 14 allows to transmit additional information, which is not as time critical as the information transmitted by the signal line 16, from the door safety units 12 to the elevator safety unit 15.

As a result, an elevator safety system according to an embodiment of the invention allows to locate errors faster and more easily than a conventional elevator safety system without reducing the level of safety.

FIG. 2 is a flow diagram illustrating the operation of a door safety unit 12.

In the following, the operation of a door safety unit 12 is explained in detail for a situation in which the door safety unit 12 checks whether the at least one landing door 10 is properly closed or not. The skilled person, however, will understand that the principles of invention, as they are described with reference to FIG. 2, may be employed similarly in the context of any malfunction detected by the door safety unit 12.

In a first step 100, it is checked, e.g. by means of a landing door sensor 17, whether the at least one landing door 10, which is associated with the respective door safety unit 12, is properly closed.

In a following step 110, the signal provided by the landing door sensor 17 is evaluated. If the at least one landing door 10 is properly closed, the electrical contact within the signal line 16 remains closed (step 110), which allows further operation of the elevator system, in particular movement of the elevator car 6.

If, however, the evaluation of the signal provided by the landing door sensor 17 shows that the associated landing door 10 is not properly closed, the contact is opened (step 125) interrupting the signal line 16 and stopping the elevator car 6, as it has been described before.

In a next step 130, it is checked, whether the status of the landing door 10 has changed. If this is the case, a message is sent over the communication bus 14 in order to inform the elevator control unit 13 about the new status of the landing door 10.

The door safety units 12 may be configured to periodically transmit information via the communication bus 14. An example of such a configuration is illustrated by the flow diagram shown in FIG. 3.

In step 200 a time counter is incremented. In a next step 210 it is checked whether a predetermined threshold has been reached. If said threshold has not been reached, the time counter is incremented again (step 200).

If, however, the predetermined threshold has been reached, a message is sent via the communicate bus 14 (step 220) in order to indicate that the door safety unit 12 is still alive and working properly.

In an alternative configuration, which is not illustrated in the figures, the elevator safety unit 15 may be configured to periodically request each of the plurality of door safety units 12 to transmit information via the communication bus 14 in order to check the operation of the door safety units 12.

Periodically transmitting information via the communication bus allows to continuously monitor the operation of the communication bus and of the door safety units connected to said communicate bus. In case a door safety unit does not send a message via the communication bus for more than a predetermined period of time, a malfunction of the communication bus and/or of the respective door safety unit is detected.

A number of optional features are set out in the following. These features may be realized in particular embodiments, alone or in combination with any of the other features.

The signal line may be provided separate from the communication bus. Providing two separate, in particular independent, paths for transmitting the information enhances the reliability of the elevator safety system.

The signal line may be a binary signal line. A binary signal line, which is switchable between only two states (e.g. “on” and “off”), allows for a very reliable operation, which enhances the security of the elevator safety system.

Each of the plurality of door safety units may be configured to interrupt the signal line in case it detects a malfunction of at least one door of the elevator system. Such a configuration allows to reliably detect a malfunction of at least one door of the elevator system.

Each of the plurality of door safety units may be configured to interrupt the signal line in case it detects that at least one door of the elevator system is not properly closed. Such a configuration allows to reliably detect that at least one door of the elevator system is not properly closed in order to avoid that passengers fall into the hoistway after the elevator car has moved away from a landing with a door which is not properly closed.

Each of the plurality of door safety units may be configured to transmit information via the communication bus to the elevator control unit, particularly to the elevator safety unit, when it detects a malfunction of at least one door of the elevator system, in particular a situation in which at least one door of the elevator system is not properly closed although it is supposed to be. The elevator control/elevator safety unit may be configured to receive information from the communication bus after the signal line has been interrupted. The elevator control unit/elevator safety unit may be configured to request the door safety units to send information via the communication bus after the signal line has been interrupted. The elevator control unit/elevator safety particularly may be configured to request that the door safety unit which interrupted the signal line sends information via the communication bus.

The information transmitted over the communication bus may be configured to allow to uniquely identify the door safety unit which interrupted signal line. This allows to locate and repair the detected malfunction fast and conveniently.

The elevator control unit may be configured to periodically request each of the plurality of door safety units to transmit information via the communication bus. Alternatively, the door safety units may be configured to periodically transmit information via the communication bus.

Periodically transmitting information via the communication bus allows to continuously monitor the operation of the communication bus and of the door safety units connected to said communication bus. In case a door safety unit does not send a message via the communication bus for more than a predetermined period of time, a malfunction of the communication bus and/or of the respective door safety unit is detected.

Each of the door safety units may be a bus node, in particular a node of a field bus, particularly a CAN bus. This allows to transmit information from the door safety units via the communication bus. A field bus/CAN bus is well suited to fulfill the requirements of a communication bus in an elevator safety system according to exemplary embodiments of the invention. Other field bus systems, as they are known and used in the art, may be used as well.

Each of the door safety units, the elevator control unit and the communication bus may fulfill the requirements for safety electronics, such as the EN 61508:2010 standard, in order to provide the required level of reliability and safety.

At least one of the door safety units may be connected to a door sensor, which is configured for monitoring the at least one door. The door sensor may be a mechanical, an inductive, a capacitive and/or an optical sensor. It in particular may be configured to detect whether the at least one door is open or closed. This allows to monitor whether the elevator system operates properly and safely. It in particular provides information which allows the elevator control unit to take measures to prevent the elevator car from moving when the hoistway doors are not properly closed.

The communication bus may comprise one or a plurality of electrical wires. A communication bus comprising at least one electrical wire may be implemented at low costs and allows for a reliable transmission of data. The communication bus in particular may be a serial bus.

The communication bus may be configured for wireless data transmission. A communication bus which is configured for wireless data transmission is easy to install, in particular in high buildings where the extension of the hoistway in the vertical direction is large.

Exemplary embodiments of the invention have been described for an elevator system comprising a single elevator car moving within a single hoistway. The skilled person, however, will understand that the invention may be employed also in elevator systems comprising a plurality of elevator cars and/or hoistways.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system
3 tension member
4 hoistway
5 drive
6 elevator car
7a landing control panel
7b car operation panel
8 landing
10 landing door
11 elevator car door
12 door safety unit
13 elevator control unit
14 communication bus
15 elevator safety unit
16 signal line
17 (landing) door sensor
18 communication unit
20 external communication line
22 external service center

1. An elevator safety system comprising:
a plurality of door safety units (12), wherein each door safety unit (12) is configured to monitor at least one door (10, 11) of an elevator system (2);
an elevator control unit (13), which is configured to control the elevator system (2), in particular to control movement of an elevator car (6) of the elevator system (2);
a communication bus (14), which is configured for transmitting information between the plurality of door safety units (12) and the elevator control unit (13); and
a signal line (16) serially connecting the elevator control unit (13) and the plurality of door safety units (12);
wherein each of the plurality of door safety units (12) is configured to selectively interrupt the signal line (16).

2. The elevator safety system according to claim 1, wherein the signal line (16) is provided separately from the communication bus (14) and/or wherein the signal line (16) is a binary signal line (16).

3. The elevator safety system according to claim 1, wherein each of the plurality of door safety units (12) is configured to interrupt the signal line (16) in case it detects a malfunction of at least one door (10, 11) of the elevator system (2).

4. The elevator safety system according to claim 1, wherein each of the plurality of door safety units (12) is configured to transmit information via the communication bus (14) to the elevator control unit (13) if it detects a malfunction of at least one door (10, 11) of the elevator system (2), wherein the information transmitted over the communication bus (14) in particular allows to uniquely identify the door safety unit (12) transmitting said information.

5. The elevator safety system according to claim 3, wherein detecting a malfunction of at least one door (10, 11) of the elevator system (2) includes detecting that the at least one door (10, 11) is not properly closed.

6. The elevator safety system according to claim 1, wherein the elevator control unit (13) is configured to receive information from the communication bus (14), in particular after the signal line (16) has been interrupted.

7. The elevator safety system according to claim 1, wherein the elevator control unit (13) is configured to periodically request each of the plurality of door safety units (12) to transmit information via the communication bus (14) and/or wherein the door safety units (12) are configured to periodically transmit information via the communication bus (14).

8. The elevator safety system according to claim 1, wherein the plurality of doors (10, 11) include at least one hoistway door (10) of the elevator system (2).

9. The elevator safety system according to claim 1, wherein each of the door safety units (12) is a bus node, in particular a node of a field bus.

10. The elevator safety system according to claim 1, wherein each of the door safety units (12), the elevator control unit (13) and the communication bus (14) fulfills the requirements for safety electronics.

11. The elevator safety system according to claim 1, wherein at least one of the door safety units (12) is connected with at least one door sensor (17) which is configured for monitoring the at least one door (10, 11), wherein the at least one door sensor (17) particularly is configured to detect whether the at least one door (10, 11) is properly closed.

12. The elevator safety system according to claim 11, wherein the at least one door sensor (17) is a mechanical, an inductive, a capacitive and/or an optical door sensor (17).

13. The elevator safety system according to claim 1, wherein the communication bus (14) comprises one or a plurality of electrical wires and/or wherein the communication bus (14) is configured for a wireless transmission of information.

14. An elevator system (2) comprising:
a hoistway (4) extending between a plurality of landings (8);
an elevator car (6), which is configured to move along the hoistway (4) between the plurality of landings (8);
a drive unit (5) which is configured for driving the elevator car (6); and
an elevator safety system according to claim 1, wherein the elevator control unit (13) of the elevator safety system is configured for controlling the drive unit (5).

15. A method of controlling the elevator system (2) according to claim 13, wherein the method comprises:
monitoring at least one door (10, 11) of an elevator system (2) by means of one of the door safety units (12); and
if a malfunction of at least one door (10, 11) is detected:
interrupting the signal line (16) and transmitting information from the door safety unit (12) interrupting the signal line (16) to the elevator control unit (13); and
stopping and preventing any movement of the elevator car (6).
